(19) United States
(12) Patent Application Publication
(10) Pub. No.: US 2026/0058590 A1
(43) Pub. Date: Feb. 26, 2026

(54) METHOD FOR OPERATING A PULSE-WIDTH MODULATED ELECTRIC MOTOR

(71) Applicant: Brose Fahrzeugteile SE & Co. Kommanditgesellschaft, Würzburg, Würzburg (DE)

(72) Inventor: Johannes SCHWARZKOPF, Marktheidenfeld (DE)

(21) Appl. No.: 19/181,598

(22) Filed: Apr. 17, 2025

(30) Foreign Application Priority Data
Apr. 17, 2024 (DE) 10 2024 203 566.1

(51) Int. Cl. H02P 27/08; H02P 23/00

(52) U.S. Cl. CPC H02P 27/08; H02P 23/00

(57) ABSTRACT

A method for operating a pulse-width modulated electric motor in which at least one bridge branch is actuated with a high-side switch and with a low-side switch in the course of the pulse-width modulation. Between a switching-off procedure of the one switch and a switching-on procedure of the other switch, a dead time is formed that is composed of a hardware dead time duration which changes during motor operation and a software dead time duration which is adjustable. The switching times for the switching procedures that limit the dead time are acquired, and the software dead time is changed as a function of the acquired switching times.

### CROSS-REFERENCE TO RELATED APPLICATION

This application claims the priority, under 35 U.S.C. § 119, of German Patent Application DE 10 2024 203 566.1, filed Apr. 17, 2024; the prior application is herewith incorporated by reference in its entirety.

### FIELD AND BACKGROUND OF THE INVENTION

The invention relates to a method for operating a pulse-width modulated electric motor in which at least one bridge branch is actuated with a high-side switch and with a low-side switch in the course of the pulse-width modulation and in which, between a switching-off procedure of the one switch and a switching-on procedure of the other switch, a dead time occurs which is formed of a hardware dead time duration which changes during motor operation and a software dead time duration which is adjustable. Furthermore, the invention relates to an electric machine and to software on a data carrier.

Adjustment systems driven or operated by an electric motor as motor vehicle components, such as, for example, window lifters, seat adjustments, door and sliding roof drives or radiator fan drives, and pumps and interior ventilators, typically have an electric drive with a controlled electric motor. For such electromotive drives, so-called brushless electric motors (brushless direct current motor, BLDC motor) are employed with increasing frequency, in which the brush elements of a rigid (mechanical) commutator which are prone to wear are replaced by electronic commutation of the motor current. For this purpose, the electric motor is generally connected to an intermediate circuit via a bridge circuit.

The multi-phase motor current is usually generated by pulse width modulation (PWM) of the bridge circuit feeding the electric motor. In PWM, the width (duration) of the voltage pulses is varied to control the average voltage and thus the energy delivered to the electric motor. This takes place by means of a specified timing scheme in which the semiconductor switches of the bridge circuit alternate in a rhythmic pattern between a conducting and a blocking state, which allows efficient and accurate control of the motor power.

In practice, a duty cycle of the PWM is utilized to control the average power delivered to a load without directly changing the voltage. By adapting the pulse width (and thus the duty cycle), the effective voltage applied to the electric motor over time can be fine-tuned.

The bridge circuit has a number of bridge branches (half bridges) corresponding to the number of motor phases. Herein, each bridge branch has a high-side switch and a low-side switch. A high-side switch is understood to mean, in particular, a switch which switches a positive or high supply voltage. That is, the high-side switch is connected, in terms of circuit technology, above the load formed by the motor phases. Correspondingly, a low-side switch is understood to mean, in particular, a switch which switches a negative or low supply voltage. That is, the low-side switch is connected, in terms of circuit technology, below the load formed by the motor phases.

The high-side switches and low-side switches are regularly embodied as (power) semiconductor switches, in particular as (power) transistors, for example as IGBTs (insulated-gate bipolar transistors) or SicMOS MOSFET GaN (SiC: silicon carbide, MOS: metal oxide semiconductor, FET: field effect transistor, GaN: gallium nitride), and each have an integrated flyback diode (body diode) herein. Herein, the term “integrated” is understood to mean, in particular, that the flyback diode is part of the semiconductor switch or forms a common component along with it. In the case of a MOSFET, the flyback diode results, for example, contingent on manufacturing within the NPN (or PNP) structure. In the case of an IGBT, by contrast, a separate component is needed to constitute this function. Herein, integrated means, in particular, that the IGBT and the flyback diode are received in a common housing and are installed/interconnected as a common component.

During PWM operation, it must be ensured that the two switches of a bridge branch are not switched to conducting at the same time. Even after switching off the switch, a current flows across the flyback diodes due to the motor inductance.

Therefore, upon switchover in the course of PWM, the active switch is first switched off and the other one is switched on subsequently. It must be ensured at all times that a switch is only switched on when the complementary switch has been switched off. For this purpose, a dead time is provided in which both switches are switched off and the electric motor cannot be commutated, so that short-circuiting of the intermediate circuit voltage is prevented. The current driven by the inductance of the electric motor flows through the (parasitic or integrated) flyback diode to the positive or negative supply voltage during this time depending on the current direction. This increases electrical losses and can entail negative acoustic effects. The greater or longer the predetermined dead time, the more inefficient the electric machine becomes during (normal) operation. Therefore, the dead time should be kept as short as possible.

A “dead time” is to be understood here and hereinafter, in particular, as that time period or time duration during the switchover in which neither a high-side switch nor a low-side switch is closed (switched to conducting) in the bridge circuit or in the bridge branch.

Herein, the dead time is periodically composed of a hardware dead time duration, which is contingent on hardware, and a software dead time duration, which is stored in software and which is adjustable.

Herein, the hardware dead time duration substantially corresponds to the hardware-contingent delay of a switching procedure. For example, when a switch embodied as a MOSFET is switched on, a signal is sent, for example, from a (micro) controller to a PWM driver which then sets its output to high and actuates a gate terminal of the switch. Subsequently, the gate of the MOSFET is charged by the current until the switch actually switches on. Due to this hardware delay, there is a time offset between a desired switching time and the actual switching time. Herein, this switching delay or hardware dead time can vary during motor operation, for example due to temperature fluctuations, ageing, or tolerances of the hardware components. In particular, the hardware dead times for the switching-on and switching-off procedures may be different. Furthermore, the hardware dead times for the high-side and low-side switches and between bridge branches may vary.

The software dead time is a stored or programmed time delay which is considered in the course of the PWM and which is sized such that the dead time, that is, the sum of the stored software dead time and the changeable hardware dead time, is always greater than a minimum dead time so that short circuits and transverse currents are reliably avoided. Herein, the software dead time is typically oversized so that even if the hardware dead time changes, it is always ensured that the minimum dead time is not undershot.

### SUMMARY OF THE INVENTION

It is accordingly an object of the invention to provide a method for operating a pulse-width modulated electric motor which overcomes the above-mentioned and other disadvantages of the heretofore-known devices and methods of this general type and which provides for a particularly advantageous such method. It is a further object of the invention to provide for a particularly suitable electric machine and a particularly suitable software.

With the above and other objects in view there is provided, in accordance with the invention, a method of operating an electric motor with pulse-width modulation, where at least one bridge branch with a high-side switch and with a low-side switch are actuated in a course of the pulse-width modulation. A dead time forms between a switching-off procedure of one switch and a switching-on procedure of the other switch. The dead time comprises a hardware dead time duration, which changes during motor operation, and a software dead time duration, which is adjustable. The method comprises:
acquiring switching times for the switching procedures bounding the dead time; and
varying the software dead time in dependence on the switching times that bound the dead time.

Herein, the statements related to the method apply mutatis mutandis to the electric machine and/or the software and vice versa. Where method steps are described below, advantageous configurations for the electric machine result in particular from the fact that it is configured to execute one or more of these method steps.

The conjunction “and/or” is to be understood here and hereinafter such that the features linked by means of this conjunction can be configured both jointly and as alternatives to one another. Similarly, the expression “at least one of A or B” should be understood to mean “A or B or A and B.”

The method according to the invention is provided for operating a pulse-width modulated electric motor, that is, an electric motor which is operated by means of pulse-width modulation (PWM), and is suitable and designed therefor. Herein, the electric motor, which is in particular multi-phase and brushless, is actuated via an inverter connected to a (direct voltage) intermediate circuit. For this purpose, the inverter has (control) electronics with logic components and a PWM driver which actuate a bridge circuit with power components (high-side switch, low-side switch) for generating a motor current/a motor voltage (phase voltage).

The intermediate circuit has an intermediate circuit capacitor (intermediate circuit capacitance) interconnected between a high path and a low path. Herein, the high path is connected to a positive or high supply voltage and the low path is connected to a negative or low supply voltage. The intermediate circuit is connected to an energy store providing the supply voltage, for example a high-voltage or vehicle battery.

The bridge circuit of the inverter has a number of bridge branches (half bridges) corresponding to the number of motor phases. Herein, each bridge branch has a high-side switch (HS switch) and a low-side switch (LS switch). The HS and LS switches are connected in series, wherein a central point between the switches is provided as an output point or tap point for the motor voltage.

The HS switches and LS switches are preferably embodied as (power) semiconductor switches, in particular as (power) transistors, for example as IGBTs or MOSFET, and each have an integrated or external flyback diode (body diode) herein.

During a switchover procedure, that is, between a switching-off procedure of the one switch and a switching-on procedure of the other switch, a dead time is provided to avoid short circuits and transverse currents. Herein, the dead time is composed of a hardware dead time duration which changes during motor operation and a software dead time duration which is adjustable. In particular, the dead time is given by the sum of the hardware dead time duration and the software dead time duration.

According to the invention, the switching times for the switching procedures limiting the dead time are acquired or measured, wherein the software dead time is changed as a function of the switching times. That is, the switching times for the running time are detected to adapt the software dead time, for example, as optimally as possible and to compensate the influence of the dead time in the best possible way. Thereby, a particularly suitable method for operating a pulse-width modulated electric motor is realized.

A “switching time” is to be understood here and hereinafter, in particular, as the specific time within a modulation cycle at which a change in the state of a switch is actually initiated.

Herein, the method can be performed both for a switchover procedure from high to low or vice versa. Furthermore, the method can also be performed in parallel for various bridge branches. For example, the method is performed for each switchover procedure of the bridge circuit.

The measurement values can be detected at selected times, for example upon power-up, upon manufacture, in particular end of line (EOL), or during the entire useful life. In other words, the method can be performed in the course of a calibration of the electric motor, upon start-up, or during motor operation.

In a preferred embodiment, a threshold comparison with a threshold is performed based on the acquired switching times, and the software dead time is changed as a function of the threshold comparison. In particular, the software dead time is used as an adjustment variable for motor or PWM operation. In other words, the software dead time is controlled based on the threshold comparison.

An “adjustment variable” is to be understood here and hereinafter, in particular, as a parameter or a measured variable which is used in a control loop for adapting and checking the pulse width modulation (PWM). When determining the adjustment variable and calculating the times (e.g., the hardware and software dead times), delay times such as, for example, the sample & hold time may be considered.

In a possible application, dead time compensation or dead time optimisation is realized during PWM operation by means of controlling the software dead time. In a conceivable design, an as-is dead time duration is determined from the acquired switching times, and a threshold comparison of the as-is dead time duration with a stored target dead time duration, in particular a minimum dead time, is performed. The software dead time is changed or controlled as a function of the threshold comparison.

Herein, in a suitable design, the software dead time is minimized, in particular. Knowing the switching times allows for minimising the dead time and compensating for the dead time in the best possible way. This in turn improves acoustics, power dissipation, and self-heating of the electric motor during motor operation. Herein, the software dead time is minimized such that the sum of the software dead time and the hardware dead time is always greater than a minimum dead time to make sure that short circuits are avoided. Herein, the minimum dead time is the threshold or the target dead time duration with which the as-is dead time duration is compared. Herein, the value for the software dead time is reduced in particular if the as-is dead time duration is greater than the target dead time duration. For example, the software dead time is reduced in a stepwise or successive manner, for example in 10 ns (nanosecond) steps, and thus the dead time during the PWM is optimized. This allows dynamic dead time compensation during the running time of the electric motor.

The hardware dead time which changes during operation is also related, for example, to a change in a desired pulse duration of the PWM pulses. In particular, the hardware-contingent delays during the switching-on procedure and/or switching-off procedure of the switches can lead to an actual as-is pulse duration deviating from the desired target pulse duration. In a further possible application, therefore, the setting of the software dead time is utilized or used to adapt the as-is pulse duration to a target pulse duration. For this purpose, an as-is pulse duration for a signal pulse (PWM pulse) of the pulse width modulation is determined based on the acquired switching times of consecutive switching-on and switching-off procedures. Subsequently, a threshold comparison of the as-is pulse duration with a target pulse duration is performed. Herein, the target pulse duration is the threshold, wherein the target pulse duration is in particular that pulse duration which is to be implemented by the pulse width modulation. In this application, the software dead time is changed or controlled as a function of the threshold comparison so that the as-is pulse duration corresponds to the target pulse duration or at least approximates it.

The (residual) dead times detected can thus also be utilized to change the actuation pulses such that a desired pulse is applied to the phase contact. If, for example, there is a delay of 1000 ns when changing to the positive phase voltage, and a delay of 600 ns when changing to the negative voltage, the pulse at the phase is 400 ns shorter than the actuation pulse. In other words, the as-is pulse duration is 400 ns shorter than the target pulse duration. If the actuation pulse is extended by 400 ns compared to the original desired pulse, the phase voltage duration corresponds to the original desired pulse duration. If, in addition, the leading edge and the trailing edge are displaced, the pulse does not only have the desired duration, but also the desired position.

Preferentially, the dead time compensation is adapted based on the measured dead time so that the generated pulse comes as close as possible to the desired pulse.

Various possibilities or variations are conceivable for detecting or measuring the switching times.

In a first embodiment, for example, a free-running clock (timer) and a reference variable are used to acquire a switching time, wherein a reading of the clock is copied and evaluated when a measured motor variable of the electric motor crosses the level of the reference variable. Herein, the motor variable is in particular a generated phase voltage for the electric motor, wherein the reference variable is a corresponding reference voltage. For example, the reference voltage is half of the sum of the positive and negative supply voltages (0.5×HS voltage level+0.5×LS voltage level). If the phase voltage crosses the reference voltage, the reading of the free-running clock is copied and subsequently evaluated.

In a further embodiment, an analogous measurement of the motor variable is performed. For this purpose, in particular, iterative acquisition or measurement of a switching time is performed by measuring a motor variable of the electric motor at an expected switching time and changing the switching time as a function thereof.

In the case of analogous phase voltage measurement, the phase voltage is thus measured at the expected switching time, and the switching time is adapted depending on the measurement value. Correspondingly, in the case of analogous phase current measurement, the phase current is measured at the expected switching time, and the switching time is adapted depending on the measurement value. The phase current can be measured both with the aid of a sum shunt and with the aid of a shunt for each single phase.

As an alternative to a single measurement in the preceding variants, multiple measurements per switching procedure can also occur.

Since the switching procedure occurs continuously, in a possible development, the threshold used as a basis for control can also be varied. If, for example, the centre of the two supply voltages is taken as the threshold, the switching procedure is not yet concluded here, however, this value is well suited, for example, for dead time compensation. For safe switching, a constant is preferentially added as well.

For example, the commands for switching off the LS switch occur at a time T1. If the current flows from the electric motor to the electronics, the phase voltage is close to the positive supply voltage when the LS switch is switched off completely. If the mean value of the supply voltage is selected as the measurement threshold, the switching procedure is not completely concluded at this time (T2). The HS switch must not be conducting until a later time (T2+constant). For the safe dead time, the sum with the constant is accordingly considered. In terms of measurement technology, however, the time T2 is easy and safe to detect and is thus more suitable for the compensation.

If a voltage value is used as the threshold, that is, if the threshold is a threshold voltage, there are various possibilities of varying the voltage amount or the voltage level of the threshold.

A first possibility is expressible by the following formula

$${U}_{SW} = a \times {U}_{HS} + ( 1 - a ) \times {U}_{LS} ,$$

wherein U_{SW} is the threshold voltage level, U_{HS} is the voltage level of the positive supply voltage, U_{LS} is the voltage level of the negative supply voltage, and a is a numerical value between zero (0) and one (1).

A further possibility is given, for example, by

$${U}_{SW} = {U}_{HS} - Δ ,$$

wherein Δ is a distance value having a value between 0 and the difference between the positive supply voltage and the negative supply voltage (Δ∈{0; U_{HS}-U_{LS}}).

Correspondingly, a further possibility for changing the threshold voltage U_{SW} is given by

$${U}_{SW} = {U}_{LS} + Δ .$$

Alternatively, a fixed or unchangeable voltage amount for the threshold voltage U_{SW} is also conceivable.

The values for the threshold voltage U_{SW} can also be selected to be different for the switching-on procedure and the switching-off procedure.

If a current value is used as the threshold, that is, if the threshold is a threshold current, there are correspondingly various possibilities of varying the current amount or the current value of the threshold.

One possibility is expressible by the following formula

$${I}_{SW} = a \times {I}_{HS} + ( 1 - a ) \times {I}_{LS} ,$$

wherein I_{SW} is the threshold current, I_{HS} is the current value after the jump, that is, after the switching-on procedure, Ius is the current value before the jump, that is, before the switching-on procedure, and a is a numerical value between zero (0) and one (1).

A further possibility is given, for example, by

$${I}_{SW} = {I}_{HS} - Δ ,$$

wherein Δ is a distance value having a value between 0 and the difference between the current values before and after the jump (Δ∈{0; I_{HS}−I_{LS}}).

Correspondingly, a further possibility for changing the threshold current I_{SW} is given by

$${U}_{SW} = {I}_{LS} + Δ .$$

The values for the threshold current I_{SW} can also be selected to be different for the switching-on procedure and the switching-off procedure.

If the current differences (I_{HS}−I_{LS}) are insufficient for safe recognition, the detection can be paused. That is, the current difference is compared, for example, with a stored difference threshold, and the detection of the threshold current I_{SW} pauses if the current difference reaches or undershoots the difference threshold. In this case, for example, the last determined threshold current I_{SW} is used until the current difference exceeds the difference threshold again. If the current difference between the two switching states is not sufficiently high, then preferentially no measurement is conducted. The dead times are thus not adapted until a minimum difference is present again. If there is a risk of the dead time changing during this time, the dead time can alternatively be increased (slowly) during this time.

The electric machine according to the invention is provided in particular as an electromotive drive in a motor vehicle, and is suitable and equipped therefor. In principle, however, the application herein is not limited to the automotive sector.

The electric machine has a pulse-width modulated and multi-phase electric motor which is embodied to be brushless with a stator and with a rotor which is rotatably mounted with respect thereto.

Furthermore, the electric machine has a bridge circuit connected or coupled to the electric motor and a controller, i.e., a control device. Herein, the bridge circuit is preferentially part of a current converter, in particular an inverter. The controller can be, for example, part of the current converter or part of an external control unit (electronic control unit, ECU). Herein, the stator has a number of phase windings which are routed to the bridge circuit, on the one hand, and interconnected in a star connection, for example at a common junction point (star point), on the other hand.

The motor operation of the electric motor is controlled by the controller using an open and/or closed loop. Herein, the controller is in general suitable and equipped—in terms of programming and/or circuit technology—for performing the method described above. The controller is thus precisely equipped to control a pulse width modulation of the electric motor using an open and/or closed loop. Furthermore, the controller is equipped to acquire and evaluate the switching times for the switching procedures limiting the dead time, wherein the software dead time, in particular stored in the controller, is changed as a function of the switching times.

In a preferred design, at least essentially, the controller is formed by a microcontroller with a processor and a data storage in which the functionality for performing the method according to the invention is implemented in the form of operating software (firmware) in terms of programming technology so that the method-if appropriate in interaction with a user-is performed automatically when executing the operating software in the microcontroller.

Within the scope of the invention, the controller may alternatively also be formed by a non-programmable electronic component, for example, an ASIC (application-specific integrated circuit), in which the functionality for performing the method is implemented by means in terms of circuit technology.

The electric machine operated using the method thus has particularly effective motor operation. In particular, it is thus possible to optimally adapt the software dead time during the running time of the electric motor and to compensate the influence in the best possible way.

An additional or further aspect of the invention provides for software, or a software product on a medium or data carrier for performing or carrying out the method described above. This means that the software is stored and carried on a non-transitory data carrier and is provided for executing the method described above, and is suitable and designed therefor. Thereby, a particularly suitable software for the operation of an electric motor is realized which is used to implement the functionality for performing the method according to the invention in terms of programming technology. The software is thus in particular operating software (firmware), wherein the data carrier is, for example, a data storage of the controller.

Other features which are considered as characteristic for the invention are set forth in the appended claims.

Although the invention is illustrated and described herein as embodied in a method for operating a pulse-width modulated electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, which show schematic and simplified representations.

### BRIEF DESCRIPTION OF THE FIGURES

FIG. 1 shows an electric machine with a current source and with an electric motor and with a current converter interconnected therebetween;

FIG. 2 shows three phase windings of a three-phase electric motor of the ma-chine in a star connection;

FIG. 3 shows a bridge module of a bridge circuit of the current converter for actuating a phase winding of the electric motor;

FIG. 4 shows an equivalent circuit diagram for the current source;

FIG. 5 shows a block diagram for pulse width modulation during the running time; and

FIG. 6 shows a flowchart for dynamic dead time control.

Corresponding parts and variables are labeled and identified with the same reference numerals throughout the figures.

### DETAILED DESCRIPTION OF THE INVENTION

The invention is explained below by way of example based on a drive with a B6 circuit and a three-phase electric motor with a star connection. However, the invention can also be applied to other arrangements. In particular, the below statements are also transferrable mutatis mutandis to a delta connection and/or multi-phase electric motors in general.

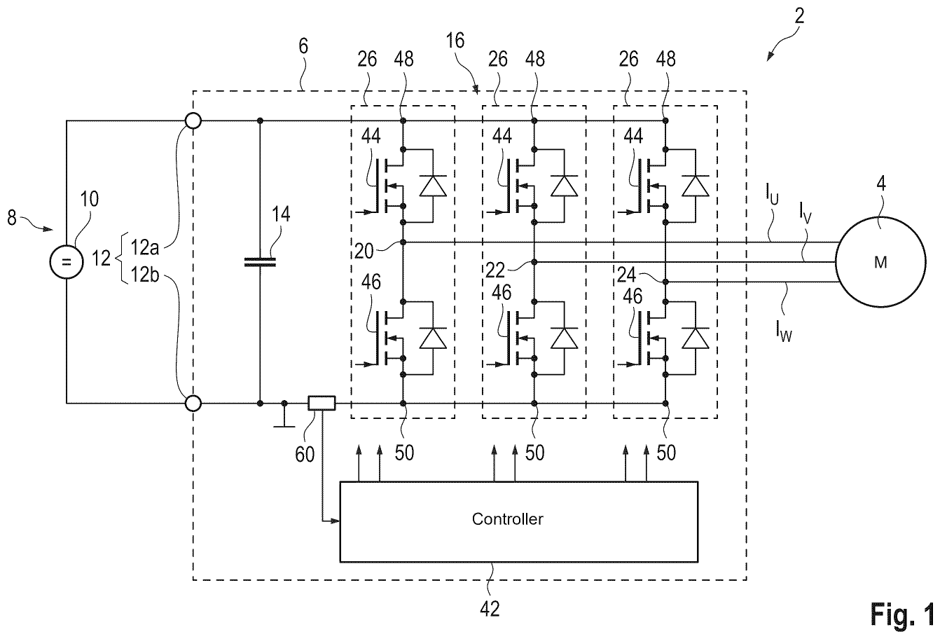

Referring now to the figures of the drawing in detail and first, in particular, to FIG. 1 thereof, there is shown an electric machine 2 for electromotive drive of a vehicle, not represented in detail, for example a motor vehicle or an electrically driven or drivable bicycle (e-bike). Herein, the machine 2 comprises a three-phase brushless electric motor 4 which is connected to a current source (voltage supply) 8 by means of a current converter (frequency changer, inverter) 6. In this exemplary embodiment, the current source 8 comprises an in-vehicle energy store in the form of a (motor vehicle) battery 10, and a (direct voltage) intermediate circuit 12 connected thereto as part of an on-board network, which at least partially extends into the current converter 6.

The intermediate circuit 12 is substantially formed by an outgoing wire (supply wire) 12a and a return wire (earth wire) 12b, by means of which the current converter 6 is connected to the battery 10. The wires 12a and 12b are at least partially routed into the current converter 6, where an intermediate circuit capacitor 14 and a bridge circuit 16 are interconnected between them.

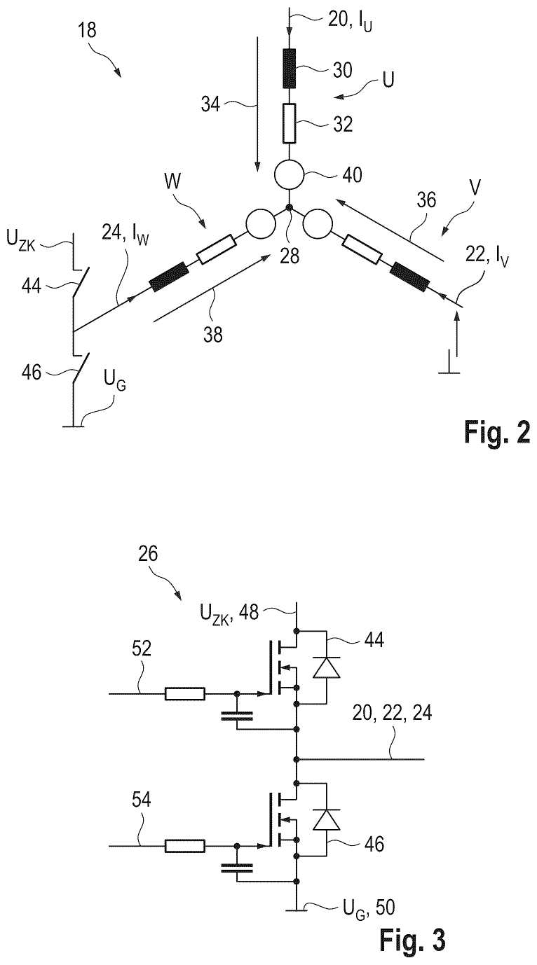

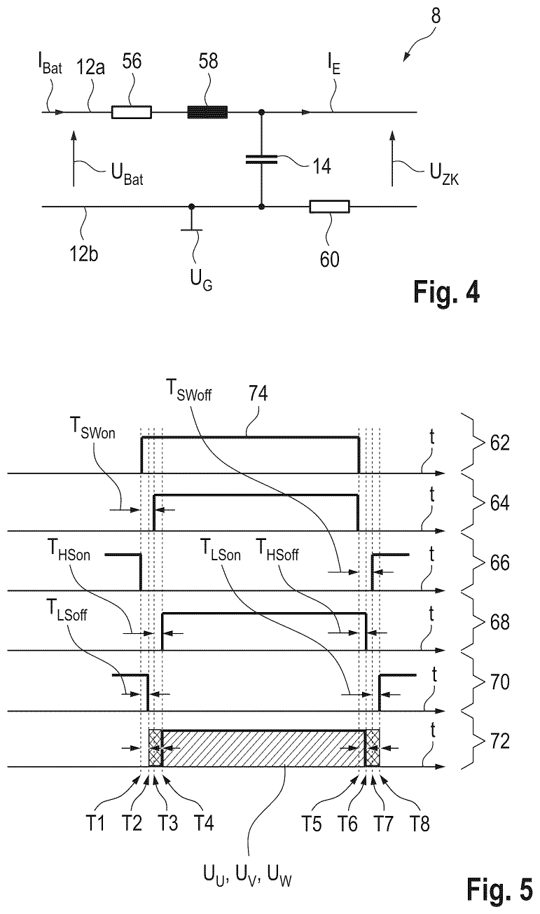

During the operation of the machine 2, an input current IE (FIG. 4) supplied to the bridge circuit 16 is converted to a three-phase output current (motor current, three-phase alternating current) I_{U}, I_{V}, I_{W} for the three phases U, V, W of the electric motor 4. The output currents I_{U}, I_{V}, I_{W} also referred to as phase currents below are routed to the corresponding phases (phase windings) U, V, W (FIG. 2) of a stator, not represented in detail.

FIG. 2 shows a star connection 18 of the three phase windings U, V, W. The phase windings U, V and W each have one (phase) end 20, 22, 24 routed to a respective bridge module 26 (FIG. 3) of the bridge circuit 16, and are interconnected to one another by the respective opposite end at a star point 28 as a common connection terminal. In the representation of FIG. 2, the phase windings U, V and W are each shown by means of an equivalent circuit diagram in the form of an inductance 30 and an ohmic resistor 32 and a respective voltage drop 34, 36, 38.

The voltage 34, 36, 38, which respectively drops across the phase windings U, V, W, is represented schematically by arrows and results from the sum of the voltage drops across the inductance 30 and the ohmic resistor 32 and the induced voltage 40. The voltage 40 (electromagnetic force, EMF, EMK) induced by a movement of a rotor of the electric motor 4 is represented in FIG. 2 using a circle.

The star connection 18 is actuated by means of the bridge circuit 16. The bridge circuit 16 is embodied, in particular, as a B6 circuit with the bridge modules 26, which are also referred to as bridge branches or half bridges below. In this design form, during operation, at each of the phase windings U, V, W, there is a switchover at a high switching frequency in a timed manner between a high (direct) voltage level of the outgoing wire 12a and a low voltage level of the return wire 12b.

Herein, the high voltage level (high-side voltage level, HS voltage level, positive supply voltage) is in particular an intermediate circuit voltage U_{ZK} of the intermediate circuit 12, wherein the low voltage level (low-side voltage level, LS voltage level, negative supply voltage) is preferentially a ground potential (earth) UG. This timed actuation is embodied as PWM actuation—represented in FIG. 1 by means of arrows—by a controller 42 which makes open-loop and/or closed-loop control of the speed, the power, and the direction of rotation of the electric motor 4 possible.

The bridge branches 26 each comprise two semiconductor switches 44 and 46, which are represented in FIG. 2 only schematically and by way of example for the phase W. The bridge module 26 is, on the one hand, connected to the outgoing wire 12a with a potential terminal 48 and thus to the intermediate circuit voltage U_{ZK}. On the other hand, the bridge module 26 is bonded with a second potential terminal 50 to the return wire 12b and thus to the ground potential UG. The respective phase end 20, 22, 24 of the phase U, V, W is connectable either to the intermediate circuit voltage U_{Zk} or to the ground potential UG via the semiconductor switches 44, 46. Below, the semiconductor switch 44 is also referred to as a high-side switch (HS switch) 44, and the semiconductor switch 46 is also referred to as a low-side switch (LS switch) 46.

If the HS switch 44 is closed (conducting) and the LS switch 46 is opened (non-conducting, blocking), then the phase end 20, 22, 24 is connected to the potential of the intermediate circuit voltage U_{ZK}. Correspondingly, upon opening the HS switch 44 and closing the LS switch 46, the phase U, V, W is bonded to the ground potential UG. Thereby, it is possible by means of the PWM actuation to apply two different voltage levels to each phase winding U, V, W.

FIG. 3 shows a single bridge branch 26 in a simplified manner. In this exemplary embodiment, the switches 44 and 46 are realized as MOSFETs (metal-oxide semiconductor field-effect transistors), which in each case switch over in a timed manner between a switched-through state and a blocking state by means of the PWM actuation. For this purpose, the respective gate terminals are routed to corresponding control voltage inputs 52, 54, by means of which the signals of the PWM actuation of the controller 42 are transmitted.

FIG. 4 shows an equivalent circuit diagram for the current source 8. During operation, the battery 10 generates a battery voltage U_{Bat} and a corresponding battery current I_{Bat} for operating the current converter 6. In FIG. 4, the internal resistance of the battery 10 is represented as an ohmic resistor 56, and an inherent inductance of the battery 10 is represented as an inductance 58. A shunt resistor 60 is connected in the return wire 12b.

Depending on the switching states of the switches 44, 46, the phase current I_{U}, I_{V}, I_{W} flows across the shunt resistor 60. The voltage drop across the shunt resistor 60 is amplified and evaluated. The phase currents I_{U}, I_{V}, I_{W} are reconstructed by the controller 42 using measurements and the state of knowledge of the switching states of the switches 44, 46. Other measurement methods may also be used to detect the motor currents (e.g., direct phase current measurement). Together with the measured and/or calculated phase voltages (U_{U}, U_{V}, U_{W}), the phase voltages (U_{U}, U_{V}, U_{W}) and the phase currents I_{U}, I_{V}, I_{W} are available to the controller 42.

The diagram of FIG. 5 comprises six horizontal sections 62, 64, 66, 68, 70, 72 arranged one above the other. Horizontally, i.e., on the X or abscissa axis, a time t is plotted in each case. By way of example, FIG. 5 represents two switchover procedures, each with a switching-on procedure and a switching-off procedure, for a PWM actuation of a bridge branch 26.

Herein, section 62 shows an output signal of the controller 42 for actuating the switches 44, 46. This output signal is supplied, for example, to a PWM driver which generates corresponding control signals for the control voltage inputs 52, 54. Herein, section 64 shows the control voltage signal for the HS switch 44, that is, the HS control input signal or HS gate signal. Herein, section 66 shows the complementary control voltage signal for the LS switch 46, that is, the LS control input signal or LS gate signal. Sections 68, 70 show the actual or real-world switching state of the HS switch 44 (section 68) and the LS switch 46 (section 70). In section 72, the variation over time of the resulting phase voltage U_{U}, U_{V}, U_{W} of the respectively actuated phase U, V, W is represented.

Below, a switching-on procedure is first explained in which the switches 44, 46 are controlled or switched such that the electric motor 4 is supplied with the phase voltage U_{U}, U_{V}, U_{W}.

At the switching time T1, the switching-on procedure is started by the controller 42. Section 62 shows a rectangular switching signal 74 which is generated by the controller 42 for PWM actuation of the switches 44, 46. The switching signal (edge) 74 has two switching edges from a low to a high voltage level (rising edge) and from the high to the low voltage level (falling edge). The rising edge is started at the switching time T1, and the falling edge is started at a later switching time T5.

At the same time or with a short delay with respect to the switching time T1, the driver output of the LS switch 46 switches to low to deactivate it (section 66). At a switching time T2, the LS switch 46 is switched off (section 70). The hardware-contingent time delay between the deactivation and the switch-off of the LS switch 46 is also referred to below as the hardware dead time T_{LSoff}. Herein, the hardware dead time T_{LSoff} is given by the difference between the switching times T2 and T1 (T_{LSoff}=T2−T1).

Depending on the current direction, the current flows across the (integrated or parasitic) flyback diode of the HS or LS switches 44, 46. Neglecting the diode voltage, the positive or negative supply voltage at the phase U, V, W results depending on the current direction.

At a switching time T3, the driver output of the HS switch 44 switches to high to activate it. For this purpose, a software dead time T_{SWon} is stored in the controller 42. Herein, the switching time T3 is given by the sum of the triggering switching time T1 and the software dead time T_{SWon}, T3=T1+T_{SWon}. In other words, the switching time T3 is delayed by the software dead time T_{SWon} with respect to the switching time T1. That is, the driver output of the HS switch 44 is actuated with a time delay with respect to the driver output of the LS switch 46. The software dead time T_{SWon} is always sized such that the switching time T3 is after the switching time T2, that is, such that the LS switch 46 is switched to non-conducting before the HS switch 44 is switched to conducting. The software dead time T_{SWon} thus ensures that the switches 44, 46 are not switched to conducting at the same time.

Subsequently, the HS switch 44 is switched on at a switching time T4. The switching time T4 is arranged after the switching time T3 due to a hardware-contingent delay. The delay is also referred to as a hardware dead time T_{HSon} below and is given by the difference between the switching times T4 and T4, T_{HSon}=T4−T3. From the switching time T4, a current flows through the HS switch 44 to the electric motor 4.

The switching-on procedure thus has one software dead time T_{SWon} and two hardware dead times T_{LSoff}, T_{HSon}. Herein, the dead time between the LS switch 46 being switched off (switching time T2) and the HS switch 44 being switched on (switching time T4), that is, the dead time for the switchover or the switchover process, is given from the sum of the software dead time T_{SWon} and the hardware dead time T_{HSon} minus the hardware dead time T_{LSoff}.

Below, a switching-off procedure is furthermore explained in which the switches 44, 46 are controlled or switched such that the electric motor 4 is no longer supplied with the phase voltage U_{U}, U_{V}, U_{W}.

At the switching time T5, the switching-off procedure is started by the controller 42 by means of the falling edge of the switching signal 74.

At the same time or with a short delay with respect to the switching time T5, the driver output of the HS switch 444 switches to low to deactivate it (section 64). At a switching time T6, the HS switch 44 is switched off (section 68). The hardware-contingent time delay between the deactivation and the switch-off of the HS switch 44 is also referred to below as the hardware dead time T_{HSoff}. Herein, the hardware dead time T_{HSoff} is given by the difference between the switching times T6 and T5, T_{HSoff}=T6−T5.

At a switching time T7, the driver output of the LS switch 46 switches to high to activate it. For this purpose, a software dead time T_{SWoff} is stored in the controller 42. Herein, the switching time T7 is given by the sum of the triggering switching time T5 and the software dead time T_{SWoff}, T7=T5+T_{SWoff}. In other words, the switching time T7 is delayed by the software dead time T_{SWoff} with respect to the switching time T5. That is, the driver output of the LS switch 46 is actuated with a time delay with respect to the driver output of the HS switch 44. The software dead time T_{SWoff} is always sized such that the switching time T7 is after the switching time T6, that is, such that the HS switch 44 is switched to non-conducting before the LS switch 46 is switched to conducting. The software dead time T_{SWoff} thus ensures that the switches 44, 46 are not switched to conducting at the same time.

Subsequently, the LS switch 46 is switched on at a switching time T8. The switching time T8 is arranged after the switching time T7 due to a hardware-contingent delay. The delay is also referred to as a hardware dead time T_{LSon} below and is given by the difference between the switching times T8 and T7, T_{LSon}=T8−T7. From the switching time T8, a current flows through the LS switch 46 to the electric motor 4.

The switching-off procedure thus has one software dead time T_{SWoff} and two hardware dead times T_{HSoff}, T_{HSoff}. Herein, the dead time between the HS switch 44 being switched off (switching time T6) and the LS switch 46 being switched on (switching time T8), that is, the dead time for the switchover or the switchover process, is given from the sum of the software dead time T_{SWoff} and the hardware dead time T_{LSon} minus the hardware dead time T_{HSoff}.

The hardware dead times T_{HSon}, T_{HSoff}, T_{LSon}, T_{LSoff} vary during operation and can have different values for the different bridge branches 26. Correspondingly, the software dead times T_{SWon}, T_{SWoff} can also have different values for the different bridge branches 26.

A method according to the invention for operating the electric motor 4 is explained in more detail below.

According to the method, the switching times T2, T4, T6 and T8 characterizing the respective dead time are detected by the controller 42 with the aid of a measuring apparatus during the running time. Depending on the current direction, T2 and T8 or T4 and T6 can be detected. Based on the switching times T2, T4, T6 and T8 and the stored software dead times T_{SWon}, T_{SWoff}, the switching times or the changing hardware dead times T_{HSon}, T_{HSoff}, T_{LSon}, T_{LSoff} for the switches 44, 46 can be determined, respectively, and thus the software dead times T_{SWon}, T_{SWoff} can be changed, preferentially minimized. If, moreover, an expected value exists for the current direction, then T1 and T4 can also be adapted to achieve a desired switching behaviour or a desired pulse duration for the generated phase voltage U_{U}, U_{V}, U_{W}, respectively.

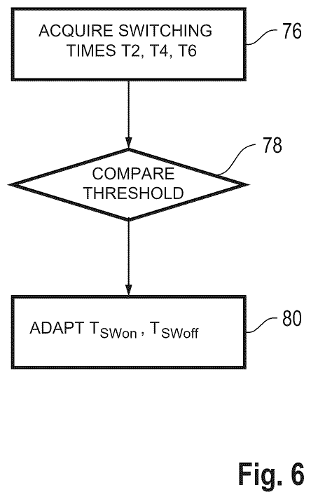

In the exemplary embodiment shown in FIG. 6, the switching times T2, T4, T6 and T8 are measured or acquired in a method step 76. In a method step 78, a threshold comparison with a threshold is performed based on the acquired switching times, and the software dead time T_{SWon}, T_{SWoff} is changed as a function of the threshold comparison in a method step 80. Herein, in particular, the software dead time T_{SWon}, T_{SWoff} is controlled, in particular minimized, based on the threshold comparison.

In a possible application, dead time compensation or dead time optimization is realized during PWM operation by means of controlling the software dead time T_{SWon}, T_{SWoff}. For this purpose, an as-is dead time duration (T4−T2, T8−T6) is determined from the acquired switching times T2, T4, T6 and T8, and a threshold comparison of the as-is dead time duration with a stored target dead time duration, in particular a minimum dead time, is performed. The software dead time T_{SWon}, T_{SWoff} is changed or controlled as a function of the threshold comparison. Herein, in particular, the software dead time T_{SWon}, T_{SWoff} is minimized.

In a further possible application, the setting of the software dead time T_{SWon}, T_{SWoff} is utilized or used to adapt the as-is pulse duration to a target pulse duration. For this purpose, an as-is pulse duration (T6−T4) for a signal pulse of the pulse width modulation (section 72) is determined based on the acquired switching times T2, T4, T6 and T8. Subsequently, a threshold comparison of the as-is pulse duration with a target pulse duration is performed. Herein, the target pulse duration is the threshold, wherein the target pulse duration is in particular that pulse duration which is to be implemented by the pulse width modulation. The target pulse duration is thus the pulse duration of the switching signal 74 (T5−T1). Due to the hardware dead times T_{HSon}, T_{HSoff}, T_{LSon}, T_{LSoff}, the as-is pulse duration (T6−T4) can deviate from the target pulse duration (T5−T1). Based on the threshold comparison, in the method step 80, for example, the switching time T1 is adapted and/or the switching time T4 is varied or controlled by changing the software dead time T_{SWon} such that the as-is pulse duration corresponds to the target pulse duration.

Various possibilities or variations are conceivable for detecting or measuring the switching times T2, T4, T6 and T8.

In a first embodiment, for example, a free-running clock (timer) of the controller 42 and a reference variable are used to acquire a switching time T2, T4, T6, T8, wherein a reading of the clock is copied and evaluated when a measured motor variable of the electric motor 4 crosses the level of the reference variable. Herein, the motor variable is in particular the generated phase voltage U_{U}, U_{V}, U_{W} for the electric motor 4, wherein the reference variable is a corresponding reference voltage. For example, the reference voltage is half of the sum of the positive and negative supply voltages. If the phase voltage crosses the reference voltage, the reading of the free-running clock is copied and subsequently evaluated.

In a further embodiment, an analogous measurement of the motor variable is performed. For this purpose, in particular, iterative acquisition or measurement of a switching time T2, T4, T6, T8 is performed by measuring a motor variable of the electric motor 4 at an expected switching time T2, T4, T6, T8 and changing the switching time T2, T4, T6, T8 or measurement time as a function thereof.

In the case of analogous phase voltage measurement, the phase voltage U_{U}, U_{V}, U_{W} is thus measured at the expected switching time T2, T4, T6, T8, and the switching time is adapted depending on the measurement value. Correspondingly, in the case of analogous phase current measurement, the phase current I_{U}, I_{V}, I_{W} is measured at the expected switching time T2, T4, T6, T8, and the switching time is adapted depending on the measurement value.

As an alternative to a single measurement in the preceding variants, multiple measurements per switching procedure can also occur.

Since the switching procedure occurs continuously, in a possible development, the threshold used as a basis for control can also be varied.

It will be understood that the invention is not limited to the embodiments described above. Rather, other variants of the invention may also be derived therefrom by a person skilled in the art within the scope of the disclosed claims without departing from the subject of the claimed invention. In particular, all the individual features described in connection with the various exemplary embodiments are also combinable in any other way within the scope of the disclosed claims without departing from the subject of the claimed invention.

The following is a summary list of reference numerals and the corresponding structure used in the above description of the invention:

| | |
|---|---|
| 2 | Electric machine |
| 4 | Electric motor |
| 6 | Current converter |
| 8 | Current source |
| 10 | Battery |
| 12 | Intermediate circuit |
| 12a | Outgoing wire |
| 12b | Return wire |
| 14 | Intermediate circuit capacitor |
| 16 | Bridge circuit |
| 18 | Star connection |
| 20, 22, 24 | Phase end |
| 26 | Bridge module, bridge branch |
| 28 | Star point |
| 30 | Inductance |
| 32 | Resistor |
| 34, 36, 38 | Voltage |
| 40 | Voltage |
| 42 | Controller |
| 44 | High-side switch, semiconductor switch |
| 46 | Low-side switch, semiconductor switch |
| 48, 50 | Potential terminal |
| 52, 54 | Control voltage input |
| 56 | Resistor |
| 58 | Inductance |
| 60 | Shunt resistor |
| 62, 64, 66, 68, 70, 72 | Section |
| 74 | Switching signal for switches 44, 46 |
| 76, 78, 80 | Method steps |
| IE | Input current |
| I_{U}, I_{V}, I_{W} | Phase current |
| U_{U}, U_{V}, U_{W} | Phase voltage |
| U, V, W | Phase |
| U_{ZK} | Intermediate circuit voltage |
| U_{G} | Ground potential |
| U_{Bat} | Battery voltage |
| I_{Bat} | Battery current |
| T1, T2, T3, T4, T5, T6, T7, T8 | Switching time |
| T_{LSoff}, T_{HSon}, T_{HSoff}, T_{LSon} | Hardware dead time |
| T_{SWon}, T_{SWoff} | Software dead time |

1. A method of operating an electric motor with pulse-width modulation, the method comprising:
actuating at least one bridge branch with a high-side switch and with a low-side switch in a course of the pulse-width modulation;
wherein a dead time forms between a switching-off procedure of one of the switches and a switching-on procedure of another one of the switches, the dead time being composed of a hardware dead time duration, which changes during motor operation, and a software dead time duration, which is adjustable;
acquiring switching times for the switching procedures bounding the dead time; and
varying the software dead time in dependence on the switching times bounding the dead time.

2. The method according to claim 1, which comprises:
based on the acquired switching times, performing a threshold comparison with a threshold; and
changing the software dead time as a function of the threshold comparison.

3. The method according to claim 2, which comprises varying the threshold.

4. The method according to claim 1, which comprises minimizing the software dead time.

5. The method according to claim 1, which comprises:
determining an as-is dead time duration from the acquired switching times;
performing a comparison between the as-is dead time duration and a target dead time duration; and
changing the software dead time in dependence on the comparison.

6. The method according to claim 1, which comprises:
determining an as-is pulse duration for a signal pulse of the pulse width modulation based on acquired switching times of consecutive switching-on and switching-off procedures;
performing a comparison of the as-is pulse duration with a target pulse duration; and
changing the software dead time in dependence on the comparison.

7. The method according to claim 1, which comprises:
using a free-running clock and a reference variable to acquire a switching time; and
copying and evaluating a reading of the clock when a measured motor variable of the electric motor crosses a level of the reference variable.

8. The method according to claim 1, which comprises acquiring a switching time iteratively by measuring a motor variable of the electric motor at an expected switching time and changing the switching time as a function thereof.

9. An electric machine, comprising:
an electric motor and a bridge circuit with at least one bridge branch for actuating said electric motor; and
a controller connected to said bridge circuit and configured for performing the method according to claim 1.

10. Software product on a non-transitory data carrier having executable code for performing the method according to claim 1 when the software is executed on a computer.
